(19) United States
(12) Patent Application Publication
(10) Pub. No.: US 2009/0062124 A1
(43) Pub. Date: Mar. 5, 2009

(54) Ethephon-induced enhancement of seedling development

(75) Inventor: John J. Burke, Lubbock, TX (US)

Correspondence Address: USDA-ARS-OFFICE OF TECHNOLOGY TRANSFER;NATIONAL CTR FOR AGRICULTURAL UTILIZATION RESEARCH, 1815 N. UNIVERSITY STREET, PEORIA, IL, 61604, US

(73) Assignee: The United States of America, as represented by the Secretary of Agriculture, Washington, DC (US)

(21) Appl. No.: 11/897,291

(22) Filed: Aug. 30, 2007

(51) Int. Cl. A01N 57/18; A01P 21/00

(52) U.S. Cl. 504/208

(57) ABSTRACT

The growth and development of agronomically important plants which are cultivated under conditions of low water stress or drought, is enhanced by an application of relatively low concentrations of ethephon to the seed or to the growing plant at a stage of growth between the cotyledon stage and the six-leaf stage. Application of the cytokinins is effective to elicit one or more effects in the resultant plant including increased lateral root development, increased root hair development along the seminal roots, thickening of the hypocotyl, increased rate of leaf development, and enhancement of the reproductive process (i.e., increased fruiting or increased rate of development of fruiting branches).

### BACKGROUND OF THE INVENTION

1. Field of the Invention

The invention is drawn to an improved method for the production of agronomically important crops with enhanced growth and yield under conditions of low-water stress.

2. Description of the Prior Art

Plant growth is affected by a variety of physical and chemical factors. Physical factors include available light, day length, moisture and temperature. Chemical factors include minerals, nitrates, cofactors, nutrients, and plant growth regulators or hormones.

Plant growth regulators can be defined as compounds or preparations which, in minute amounts, alter the behavior of ornamental or crop plants and/or the products of such plants through physiological (hormonal) rather than physical action. They may either accelerate or retard growth, prolong or break a dormant condition, promote rooting, fruit-set, or increase fruit size or quantity, or affect the growth and/or productivity of plants in other ways. Plant growth regulators are commonly classified into one or more of six categories: auxins, gibberellins, cytokinins, ethylene generators, inhibitors, and retardants. Examples of known auxins include indole acetic acid, 2,4-D (2,4-dichlorophenoxyacetic acid), MCPA (4-chloro-2-methyl phenoxyacetic acid), MCPB (4-[4-chloro-o-tolyloxy]butyric acid) which susceptible plants oxidize to MCPA, and BNOA (beta-napthoxyacetic acid). Gibberellins include gibberellic acid and its derivatives, while cytokinins include compositions such as zeatin, kinetin (6-furfurylamino purine), benzyladenine (6-benzylamino purine or BAP), and benzyl anidene. Known ethylene generators include ethylene and Ethephon (2-chloroethyl)phosphoric acid, while known inhibitors include benzoic acid, gallic acid, and cinnamic acid, and retardants include compositions which are especially useful in plant height control, particularly in commercial greenhouse-grown floricultural crops.

### SUMMARY OF THE INVENTION

I have now discovered a novel process for enhancing the growth and development of agronomically important crops which are grown under conditions of water-deficit stress or drought. Application of relatively low concentrations of the ethylene-generating compound, ethephon, to a seed or to a growing plant at a stage of growth between the cotyledon stage and the six-leaf stage, is effective to enhance seedling growth and development in the treated plant in general. Responses in the thus treated plants include, but are not limited to, one or more of increased lateral root development, increased root hair development along the seminal roots, thickening of the hypocotyl, increased rate of leaf development, and overall enhancement of the reproductive process (including increased fruiting or increased rate of development of fruiting branches), all in comparison to an untreated control. This allows the seedling and plant to avoid water-deficit stress-induced growth reductions which would otherwise occur if the plant or seed was not treated.

In accordance with this discovery, it is an object of this invention to provide an improved process for growing agronomically important crops.

Another object of this invention to provide an improved process for growing agronomically important crops which are subjected to conditions of low water availability or even drought.

Yet another object of this invention is to provide an improved process for growing agronomically important crops with reduced susceptibility to water-deficit stress, thereby allowing growth under relatively dry conditions with reduced or no irrigation.

A further object of this invention to provide an improved process for growing agronomically important crops with increased yields.

Other objects and advantages of this invention will become readily apparent from the ensuing description.

### BRIEF DESCRIPTION OF THE DRAWINGS

FIG. 1 shows the results of dryland cotton treated with 3.8 mM ethephon at various stages of development as described in Example 2.

FIG. 2 shows the results of soybean seedlings treated with ethephon in greenhouse conditions as described in Example 3.

FIG. 3 shows the results of soybean seedlings treated with various concentrations of ethephon at various stages of development as described in Example 3.

FIG. 4 shows the results of corn seedlings treated with various concentrations of ethephon as described in Example 4.

### DETAILED DESCRIPTION OF THE INVENTION

As noted hereinabove, ethephon is a known, ethylene-releasing plant growth regulator of the formula (2-chloroethyl)phosphonic acid, ClCH₂—CH₂PO(OH)₂. The compound has been previously described for use in agricultural applications, primarily for controlling the growth and ripening of fruit crops. In each of these compositions, the compound is typically applied to plants at a late stage of growth and at high concentrations. Freytag et al. (U.S. Pat. No. 3,661,549) also described the use of ethylene, or ethylene generating compounds such as β-chloroethylphosphonic acid, to increase yields of a variety of plants, including maize, wheat, cotton, and soybeans. In accordance with this prior art process the ethylene was injected into the soil near the growing plants. In contrast with these previous applications, the process of the instant invention is drawn to the treatment of plants which are cultivated or grown under conditions of water-deficit stress or drought. I have discovered that the application of ethephon to seeds or to the growing plant at an early stage significantly increases their root system development and density, and may also increase their cuticle development, thereby enhancing their extraction and utilization of available water from the soil and increasing their resistance to water loss, respectively, and consequently minimizing the impact of the stress on the plants caused by the low water levels. Without being limited to theory, this ethephon enhancement of root development provides a greater root surface area to uptake a set amount of water. That will result in less water removed per unit of root, and the root cells would not perceive the same water-deficit stress signal as the plant with the smaller root system.

The process of the invention is effective for enhancing the growth and development of a wide of agronomically important crops, including both monocots and dicots. Without being limited thereto, preferred plants or their seeds which may be treated in this process include cotton, soybean, peppers, including chili peppers, grasses, maize, and wheat. To be effective, the ethephon is applied at a relatively low concentration to plant seeds or to plants which are at an early stage of development, specifically plants at a stage of growth between (and including) the cotyledon stage and the six-leaf stage. Although cotton seeds possess cotyledons, they are not true leaves. Thus, as it applies to cotton, the cotyledon stage is defined herein as the period when the seedling has emerged from the ground but has not yet generated true leaves.

When applied in the manner described above, ethephon unexpectedly elicits one or more or all effects in the treated plants including: increased lateral root development, increased root hair development along the seminal roots, thickening of the hypocotyl, and increased rate of leaf development, enhancement of the reproductive process (i.e., increased fruiting or increased rate of development of fruiting branches), all in comparison to an untreated control. The skilled practitioner will recognize that in cotton, increased fruiting may be evidenced by an increased number of cotton squares formed (i.e., increased boll development, wherein square refers to the flower bud of a cotton plant with a central corolla containing the pollen anthers and sepals and surrounded by three or sometimes four bracts). These effects are significant after a single application. Surprisingly, these effects are evident in plants grown in geographical areas wherein the availability of water to the plant (from rainfall and provided through irrigation, combined) is normally substantially below that necessary for optimal growth, and thus the plants would be subjected to water deficit stress. As used herein, low-water (or water deficit) is defined herein as a total amount of water from rainfall plus irrigation over the course of the growing season of the target plant, from planting to harvest, which is substantially below the amount which would provide optimum growth (i.e., yield) of the same plant when not treated with ethephon as described herein. The actual amount of water which constitutes a low-water condition will of course vary with the particular crop of interest and the variety thereof, soil conditions, and geography, and may be readily determined by the skilled practitioner. Specifically, plant water stress may be measured using techniques conventional in the art, such as measures of leaf water potential (Fisher D B, Cash-Clark C E, 2000, Gradients in water potential and turgor pressure along the translocation pathway during grain filling in normally watered and water-stressed wheat plants, Plant Physiol, 123: 139-148) or elevated leaf temperatures (Leinonen I, Jones H G, 2004, Combining thermal and visible imagery for estimating canopy temperature and identifying plant stress, J Exp Bot, 55: 1423-1431). This process therefore enables crops to be grown with increased yields in water limited environments with no or significantly reduced use of irrigation. Without being limited thereto, the process is particularly preferred for the treatment of crops grown in dryland areas such as Western Plains states of the U.S., including the High Plains of Texas, Mexico, and parts of Africa.

The potency of ethephon dictates that it should be applied in conjunction with an agronomically acceptable inert carrier or vehicle as is known in the art. As a practical matter, it is envisioned that compositions of ethephon will be prepared from commercially available or pure ethephon formulated as a solution in an inert liquid phase carrier or diluent such as water. Preferred compositions are prepared as aqueous solutions. Although water is the preferred carrier, it is envisioned that other carriers may also be used, including but not limited to alcohols or oils, inert solids such as talc, vermiculite, silicates, kaolin, cellulose or sugars, and wettable powders. The ethephon may be optionally further formulated with one or more conventional additives, such as emulsifiers or surfactants (such as in oil-based formulations), wetting agents, UV stabilizers, preservatives, antioxidants, adherents, herbicidal agents, fungicidal agents, and insecticidal agents. The ethephon may also be used alone or with other plant growth regulators or plant hormones. The term plant growth regulator or hormone as used herein refers to a naturally occurring or synthetic compound that acts as a hormone in regulating plant growth, such as auxins, gibberellins, brassinolides, and their derivatives, as well as ethylene generators.

Compositions of ethephon may be applied, for example, in the form of directly sprayable solutions, powders, suspensions (including oily or other suspensions), dispersions, emulsions, oil dispersions, pastes, dusts, broadcasting agents or granules, by spraying, atomizing, dusting, broadcasting, watering or dipping (primarily for seeds). Under cultivation conditions, ethephon is applied to the locus of the plants growing in the field (i.e., in vivo), preferably on the shoots, stem, cotyledons, and/or foliage (leaves). Seeds are typically treated prior to or concurrent with planting, such as by dipping, spraying or otherwise contacting the seed with a formulation of ethephon.

As described above, ethephon enhances crop growth and development by eliciting one or more effects including: increased lateral root development, increased root hair development along the seminal roots, thickening of the hypocotyl, increased rate of leaf development, enhancement of the reproductive process (i.e., increased fruiting or increased rate of development of fruiting branches). The amount of ethephon that is effective is critical, and is selected to induce one or more of these responses as determined by routine testing. An effective amount is defined herein as that amount which will result in a significant change in the selected response in a test group as compared to an untreated control. For example, where the ultimate effect is increased rate of development of fruiting branches, increased number of cotton squares formed, thickening of the hypocotyl, or increased root development, an effective amount is defined as those quantities which will result in a significant increase in the rate of development of fruiting branches, number of cotton squares formed, hypocotyl thickness, or root development, respectively, in a test group as compared to an untreated control. However, the amount of ethephon should be less than that which may cause significant harm or damage to the plant, or reduce growth. The actual effective amount will vary with the specific crop treated and its variety, the growth stage of the plant or seed, environmental conditions, the application technique, and the formulation, and may be readily determined by the practitioner skilled in the art. Specifically, we have found that effective amounts of applied ethephon may be highest for seeds, and that when applied to growing plants, the effective amounts for monocots may be higher than for dicots. Thus, without being limited thereto, for the treatment of growing Monocotyledones plants from the cotyledon stage up to the 2-, 4-, or 6-leaf stage, single pass spray applications of aqueous formulations containing from about 1 mM to about 25 mM ethephon are effective, with about 1 to about 20 mM being preferred, and about 7 to about 11 mM being particularly preferred. In contrast, for the treatment of Dicotyledonous plants at the same stage of growth, single pass spray applications of aqueous formulations containing from about 1 mM up to about 10 mM ethephon are effective, with about 1 to about 8 mM being preferred, and about 5 to about 7 mM being particularly preferred. When treating seeds, the amount of ethephon may be significantly higher, and formulations containing from about 5 mM up to about 200 mM ethephon are effective (seeds soaked in an aqueous formulation for approximately 10 seconds). Expressed as the amount of ethephon per acre at a typical application rate of 10 gallons per acre, for the treatment of growing plants from the cotyledon stage to the 2-, 4-, or 6-leaf stage, effective application rates for monocots may range from about 5 g ethephon/acre up to about 140 g/acre, with about 5 g/acre up to about 100 g/acre being preferred, and about 38 g/acre up to about 61 g/acre being particularly preferred. Similarly, for the treatment of dicots, effective application rates may range from about 5 g ethephon/acre up to about 55 g/acre, with about 5 g/acre up to about 45 g/acre being preferred, and about 27 g/acre up to about 39 g/acre being particularly preferred.

The following examples are intended only to further illustrate the invention and are not intended to limit the scope of the invention that is defined by the claims.

### EXAMPLE 1

Cotton plants were treated with ethephon in greenhouse conditions to evaluate the effects of ethephon application. All plants in the treatment groups received a single application by spraying of various concentrations of aqueous solutions of ethephon (0, 1.0, 3.8, 7.6, and 15.2 mM ethephon) to plants at the cotyledon stage. Lateral root production, leaf numbers and leaf size, and number of cotton squares were determined 7 to 80 days after spraying. To evaluate the effect on as a seed treatment, cotton seeds were soaked in aqueous ethephon solutions (10, 20, 30, and 50 mM) for 10 seconds prior to planting.

Sprayed cotton exhibited statistically significant increases in lateral root development, rate of leaf production (measured as numbers of leaves) without a decrease in leaf size, and increased fruiting (number of cotton squares). Optimum results were evidenced with the 3.8 mM ethephon treatment. The results of cotton square measurements following treatment with 3.8 mM ethephon are shown in Table 1. As shown therein, treatment with 3.8 mM ethephon resulted in a 30% increase in fruiting sites (cotton squares). Similar results were found with plants grown from the ethephon soaked cotton seeds, and the optimum seed soak occurred at 30 mM.

TABLE 1

| | | Number | Average |
|---|---|---|---|
| | | of | # of |
| Treatment | Rep | squares | squares |
| Control | 1 | 46 | |
| Control | 2 | 35 | 42 |
| Control | 3 | 44 | |
| 3.8 mM | 1 | 53 | |
| Ethephon | | | |
| 3.8 mM | 2 | 58 | 55 |
| Ethephon | | | |
| 3.8 mM | 3 | 54 | |
| Ethephon | | | |

### EXAMPLE 2

The effects of ethephon treatment on dryland field grown cotton were measured. All plants in the treatment groups received a single application by spraying of 3.8 mM ethephon at either the cotyledon stage, two leaf stage, and four leaf stage. Cotton yields, measured as seed cotton weight, were measured at the end of the season following harvest.

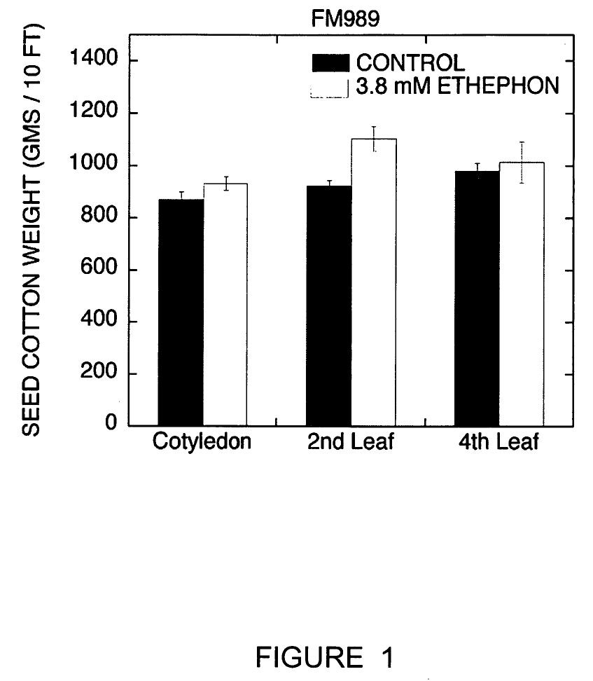

The results are shown in FIG. 1. In all bar graphs, ethephon treated cotton varieties are shown in white, while untreated controls are shown in black. As shown therein, ethephon treated plants exhibited significantly increased yields compared to non-treated controls.

### EXAMPLE 3

Soybean seedlings (46G02 RR/STS, Kelly Green Seeds) at the cotyledon—second leaf stage were treated with ethephon in greenhouse conditions to evaluate the effects of ethephon application. All plants in the treatment groups received a single application by spraying of various concentrations of aqueous solutions of ethephon (0, 1.0, 3.8, 7.6, and 15.2 mM ethephon) to plants at the cotyledon stage. Root development, measured as tap root and lateral root lengths, and seedling growth were determined 7 days after spraying.

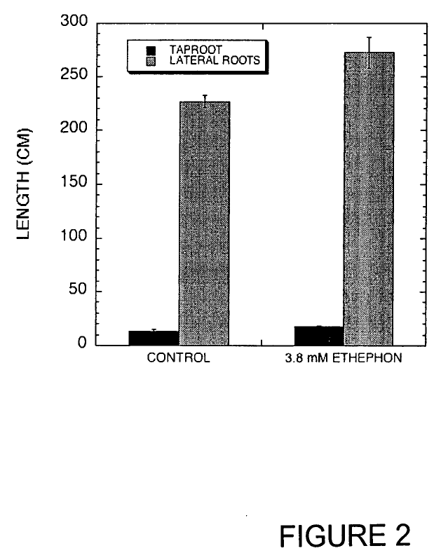

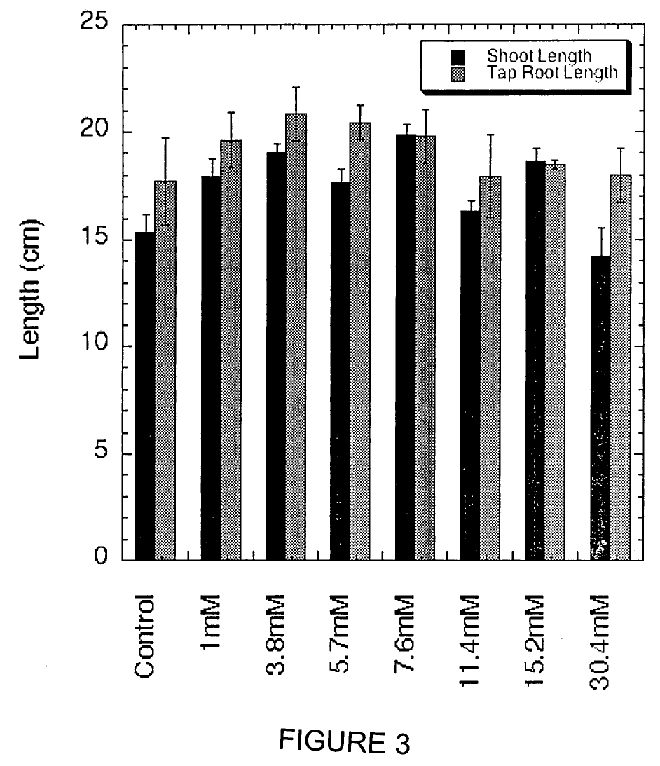

Sprayed soybean seedlings exhibited statistically significant increases in taproot and lateral root development, and seedling growth in comparison to untreated controls. As with cotton, optimum results were evidenced with the 3.8 mM ethephon treatment. The results of root development are shown in FIG. 2. Tap roots are shown in grey and Lateral roots are shown in black. Again, optimum results were evidenced with the 3.8 mM ethephon treatment. The results of taproot and shoot development are shown in FIG. 3. Tap roots are shown in grey and shoot lengths are shown in black.

### EXAMPLE 4

The effects of ethephon treatment on the root development of corn and wheat was evaluated. Corn and wheat seedlings at the two to three leaf stage were treated with ethephon in greenhouse conditions. All plants in the treatment groups received a single application by spraying of various concentrations of aqueous solutions of ethephon (0, 1.0, 3.8, 7.6, 11.4, 15.2 and 30.4 mM ethephon for wheat, and 0, 3.8, 5.7, 7.6, 11.4, 15.2, 30.4, 45.6, and 0.8 mM ethephon for corn) to plants at the cotyledon stage. Root development, measured as tap root and lateral root lengths for corn and tap root length for wheat, and shoot length and root hair production were also determined for wheat, seven days after spraying. To evaluate the effect on as a seed treatment, wheat and corn seeds were soaked in aqueous ethephon solutions (90 mM) for 10 seconds prior to planting.

Sprayed wheat seedlings treated with between 1 mM and 7.6 mM ethephon exhibited statistically significant increases in taproot length and shoot length in comparison to untreated controls.

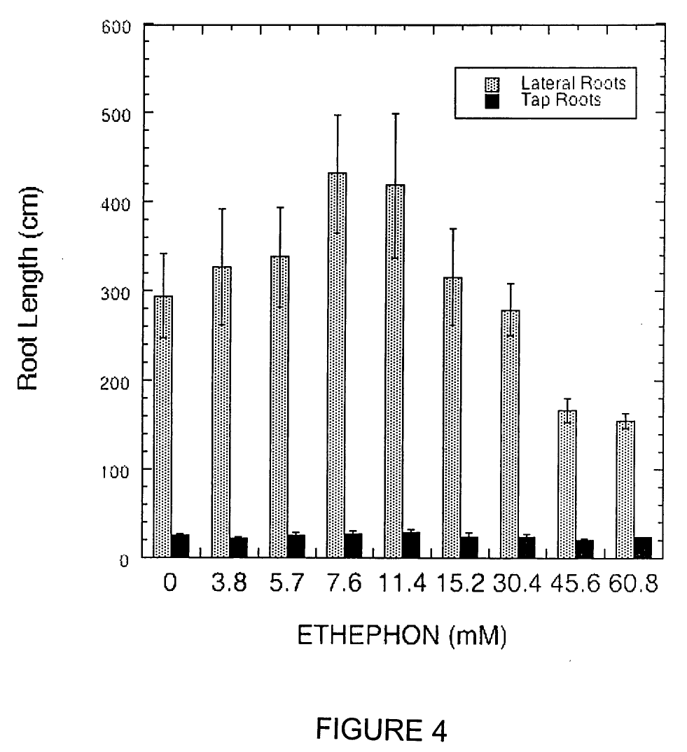

Sprayed corn treated with between 3.8 and 11.4 mM ethephon exhibited statistically significant increases in taproot length and lateral root length in comparison to untreated controls. Optimum results were evidenced with the 7.6 mM ethephon treatment. The results are shown in FIG. 4. Lateral roots are shown in grey and tap root lengths are shown in black.

It is understood that the foregoing detailed description is given merely by way of illustration and that modifications and variations may be made therein without departing from the spirit and scope of the invention.

I claim:

1. A process for enhancing the growth and development of agronomically important plants comprising applying ethephon to seed or a growing plant at a stage of growth between and including a plant at the cotyledon stage up to and including a plant at the six-leaf stage, and further wherein said ethephon is applied to said seed or said plants which are cultivated under conditions of water-deficit stress or drought and is applied at a concentration effective to elicit one or more effects in the plant selected from the group consisting of increased lateral root development, increased root hair development along the seminal roots, thickening of the hypocotyl, increased rate of leaf development, enhancement of the reproductive process, all in comparison to an untreated control.

2. The process of claim 1 wherein said ethephon is applied to said growing plant and said ethephon is formulated in a solution wherein the concentration of ethephon is between about 1 mM to about 25 mM.

3. The process of claim 2 wherein said plant is at a two-, four-, or six-leaf stage.

4. The process of claim 2 wherein said plant comprises a dicot and said concentration of ethephon is between about 1 mM to about 10 mM.

5. The process of claim 4 wherein said concentration of ethephon is between about 3 mM to about 8 mM.

6. The process of claim 2 wherein said plant comprises a monocot and said concentration of ethephon is between about 1 mM to about 25 mM.

7. The process of claim 6 wherein said concentration of ethephon is between about 7 mM to about 11 mM.

8. The process of claim 2 wherein said plant is at a cotyledon stage.

9. The process of claim 1 wherein said ethephon is applied to said seed and said concentration of ethephon is between about 5 mM to about 200 mM.

10. The process of claim 1 wherein said seed or plant is selected from the group consisting of cotton, soybean, peppers, grasses, maize, and wheat.

11. The process of claim 11 wherein said seed or plant is cotton.

12. The process of claim 1, wherein said ethephon is applied in vivo, at a location on said growing cotton plant selected from the group consisting of a shoot, stem, cotyledon, and foliage.

13. The process of claim 1, wherein said plant is grown in the absence of a significant amount of irrigation.

14. The process of claim 1 wherein said concentration of said ethephon is less than that effective to significantly damage said plant.
